(19) United States
(12) Patent Application Publication
(10) Pub. No.: US 2007/0190505 A1
(43) Pub. Date: Aug. 16, 2007

(54) Method for establishing knowledge in long-term memory

(75) Inventors: Serge Hugonnard-Bruyere, Ajaccio (FR); Marie-Christine Hugonnard-Bruyere, Ajaccio (FR)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: Polaris Industries, Inc.

(21) Appl. No.: 11/345,133

(22) Filed: Jan. 31, 2006

(51) Int. Cl. G09B 19/00

(52) U.S. Cl. 434/236

(57) ABSTRACT

A knowledge management system to optimize the human learning and memorization process. Memorization of desired information is achieved through knowledge transfer and rehearsal, whereby a learning system provides a series of associated elements to the user using a dynamical and reactive algorithm that responds to the user's abilities to prepare an efficient rehearsal process. The instant system combines a dynamic learning system with a database that comprises content provided by multiple users and which is overseen by individuals to ensure the validity of the content within the system. Information may be provided in a multimedia format which can include music, video, text and other auditory and visual stimuli as part of the rehearsal process.

### FIELD OF THE INVENTION

The present invention relates generally to systems of learning and recognition, specifically to systems of knowledge transfer that facilitate establishing knowledge in a user's long term memory and allow for knowledge transfer among multiple users.

### BACKGROUND OF THE INVENTION

1. Associative Memory

Neuroscience research has shown that a combination of factors affects the efficiency of the learning and memorization process. These factors include frequency of review, intensity of application, cross-training across different stimuli (visual and auditory, for example) or through the use of different tasks (fill in the blank versus multiple choice, for example), adaptability of the task to the user, and motivation/reward for correct responses.

Associative memory, the memory that A goes with or equals B, is a fundamental component of human intelligence. A and B can be concepts, words, symbols, and can be in a format accessible by any one or more of the five senses (auditory, visual, touch, olfactory, taste).

Forming long term associations in the mind requires repeated learning trials in which the associated elements (A and B) are repeatedly presented together as stimuli. This process can involve several stages, each stage having a particular time course. Often, there is a temporal pattern of specific repetition required to move an association from short term to long term memory. For example, to associate the English word “potato” with the French word for potato “pomme de terre” generally requires a repetition within the first few seconds of first being presented with the association, then another repetition within a few minutes, then a few hours, a few days, and so on. The number of such repetition cycles needed will vary from user to user and depend on associations and knowledge each user already has. The amount of review needed until information becomes a part of a user's long-term memory can be reduced and the learning process streamlined by establishing a system in which the user is presented with information, reviewed on that information in a variety of ways, and further challenged with deeper understanding or by learning associated information upon successfully learning the first set of information.

2. Learning Systems

Conventional practice with systems to aid with associative learning leaves control over learning cycles to the individual user. Even systems that utilize computer software and utilities will not generally optimize a repetition sequence according to the temporal dynamics of the memory formation of the individual user, as well as that user's familiarity with and evolving perception and understanding of the elements being presented for memorization. Such a system is lacking in the art, due to the innate difficulty of building a single system that can adapt to the needs and characteristics of the individual user.

Computer-controlled learning systems that work toward optimizing temporal learning patterns have been described in the literature (see, e.g., WO 03/067555 entitled “A System and Method to Optimize Human Associative Memory and to Enhance Human Memory). Such systems use a “memory engine” by providing drills at specific time intervals. Many such systems provide educational programs using some kind of computer processor. For example, that the cited PCT patent application describes a system that presents visual or acoustic stimuli as a pair or set of associated elements and then charts an individual's progress through a particular set of associative learning tasks. The system in this reference is based upon a theory of a “golden measure” of time intervals which are geared toward optimizing learning by offering review sessions at discrete intervals of time. Such a system does not, however, respond to an individual's unique performance during a review, learning and quiz process by offering alternative content to transfer into the user's memory upon successful “memorization” of a target set of content.

U.S. Pat. No. 6,139,330 titled “Computer-Aided Learning System and Method” also teaches a method to test a user on a number of different topics. The system described in this reference prompts the user's learning by disabling an aspect of the computer, such as a device driver, until a particular task has been accomplished. This system lacks the ability to respond to the user's aptitude and performance, and is static in that a particular learning task is presented, which, once completed, serves to re-enable the disabled part of the system.

U.S. Patent Application 2003/0175667 entitled “Systems and Methods for Recognition Learning” describes a computer-aided system of learning geared toward the memorization of a series of objects using a game apparatus as a backdrop to the learning process. In particular, embodiments for helping individuals identify known criminals and recently released offenders using a variety of databases are discussed. This system is not, however, able to dynamically adapt to a user's ability to answer specific interrogatories by increasing the level of difficulty or by providing alternative information sets. The system disclosed in the reference is thus not suitable for establishing a system of review and learning of information related to particular topics or sets of data.

U.S. Patent Application 2004/0180311 entitled “Method and Apparatus for Automated Training of Language Learning Skills” describes a computer software program for teaching children to read. This system fails to provide a learning system for anything other than reading and vocabulary learning, and its structure is not suitable for the learning of concepts in the adult world, as its motivational impetus uses the bright colors and amusing pictures typical of children's animation programs.

U.S. Patent Application entitled “Memory Tests using Item-Specific Weighted Memory Measurements and Uses Thereof” discusses a memory system that weights items in a serial list differently in order to distinguish between Alzheimer's patients suffering from dementia from patients that are not. The system does not, however, provide a dynamic system that responds to an individual user's performance on a memory test, but instead uses probability measurements and associative learning model predictions to weight particular items differently to calculate the score of each participant in the learning trial. This tool is perhaps best used to compare memory performance between two or more individuals, but not to provide a method to increase an individual user's ability to memorize or learn a particular set of elements.

U.S. Patent Application No. 2003/0077559 entitled “Method and Apparatus for Periodically Questioning a User Using a Computer System or Other Device to Facilitate Memorization and Learning of Information” teaches a computer aided learning system that will prompt a user's memory at differing time intervals to ensure that the information has remained in the user's long term memory. This system does not, however, respond to a user's proficiency with the knowledge and respond to that proficiency with an increased level of questions or a new set of information to learn. In addition, the described system establishes a review session by suspending other applications of the computer—for example, suspending a video game until a child who needs to review vocabulary words has completed a review session. The system thus removes user control over the process of review and learning.

From the above it should be clear that conventional systems do not provide a complete learning environment that has the ability to dynamically respond to the ability of an individual user to answer questions by providing alternative, generally more difficult, content to learn.

### SUMMARY OF THE INVENTION

In embodiments of the present invention, a system is provided to optimize the human learning and memorization process. This is achieved through knowledge transfer and rehearsal, whereby a learning system provides a series of associated elements to the user using a dynamical and reactive algorithm that responds to the user's abilities to prepare the most efficient rehearsal process. The instant system combines a dynamic learning system with a database that comprises content provided by multiple users and overseen by individuals to ensure the validity of the content within the system. Information may be provided in a multimedia format which can include music, video, text and other auditory and visual stimuli as part of the rehearsal process.

Various embodiments of the present invention may be deployed as Internet-accessible applications (e.g., via the World Wide Web as accessed through a client device operating a Web browser or similar software application). The client device may be a personal computer (of any configuration), a hand-held computer or similar device (e.g., a personal digital assistant, mobile telephone with browser capabilities, etc.). In addition, embodiments of the present invention may be deployed as stand-alone applications for such computer devices (e.g., as are sorted as application programs on computer-readable media accessible by computer processors associated with such devices).

In one embodiment of the present invention, knowledge transfer is achieved by providing an educational system; populating said educational system with a set of associative elements; and rehearsing said elements by means of an algorithm designed to adapt to a user's performance during each cycle of rehearsal, such that the user is always provided with elements appropriate to the user's current level of comprehension and memorization. An interface for providing a user access to the educational system is preferably provided, thereby allowing the user to populate the educational system with the set of associative elements and offering the user means for initiating and participating in a rehearsal process.

In various embodiments of the present invention, content to be memorized by a user is received at the educational system via a network and from a first user. This content may then be provided to a second user of the educational system via the automated rehearsal process (e.g., on a periodic basis) which is based on a rehearsal algorithm configured to determine which elements of the associative elements to provide for memorization and at what frequency, based upon the second user's past performance in interacting with the system. Memorization activities may be geared towards literary comprehension, in which case the associative elements may be based on vocabulary word lists generated from literary works, literary work authors, and literary work content. Alternatively, or in addition, the memorization activities may concern comprehension of institutional guidelines, wherein an institution with turnover in personnel can ensure that information key to the institution's functioning remains current and in the possession of the proper individuals of that institution.

In various embodiments of the present invention, the educational system includes a database containing sets of associated elements; an interface that provides a user with access to the database; a processor that executes computer readable instructions which cause the processor to provide for user selection options from the database for learning, memorization or review; and, further, which determine a next set of associated elements to present to the user based on the user's performance with a first set of elements. The review, learning and quiz process may be administered by a third party serving to guide the user in said user's process of learning and memorization.

The present invention will be more fully understood from the following detailed description of the embodiments thereof, taken together with the drawings, a brief description of which follows.

### BRIEF DESCRIPTION OF THE DRAWINGS

The present invention is illustrated by way of example, and not limitation, in the figures of the accompanying drawings, in which:

FIG. 1 is a block diagram illustrating a computer system configured for use with the present invention according to embodiments thereof.

FIG. 2 shows a flowchart illustrating an embodiment of a review process of the present invention.

FIG. 3 shows a flowchart illustrating an embodiment of a learning process of the present invention.

FIG. 4 shows a flowchart illustrating an embodiment of a quiz process of the present invention.

FIG. 5 shows a flowchart illustrating an embodiment of a subscription process of the present invention.

### DETAILED DESCRIPTION

Described herein are examples of systems for learning and recognition, specifically systems for facilitating knowledge transfer so as to establish desired knowledge in a user's long term memory and allow for knowledge transfer among multiple users. The present invention is based on the concept of a tool to assist a user in knowledge management. This assistance is provided by a structured and dynamic knowledge base that includes knowledge to be maintained, a method for creating a plan for learning and memorizing that knowledge, and the ultimate questions the user would like to be able to answer based on the knowledge contained within the knowledge base.

Before describing the present invention in detail, however, it should be recognized that the embodiments described below and with reference to the accompanying figures are meant to serve merely as examples and should not be read as limiting the broader scope of the invention as reflected in the claims set forth at the end of this discussion. Moreover, various embodiments of the present invention may be implemented with the aid of computer-implemented processes or methods (a.k.a. programs or routines) that may be rendered in any computer language including, without limitation, C#, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ and the like. In general, however, all of the aforementioned terms as used herein are meant to encompass any series of logical steps performed in a sequence to accomplish a given purpose.

In one embodiment of the present invention, the methods described herein may be developed and deployed using an application development environment known as ASP.NET, produced by Microsoft Corp. of Redmond, Wash. ASP.NET controls enable an HTML-like style of declarative programming that allows programmers to build web pages suitable for rendering in most commercially available web browsers with less code than is required with other programming solutions. Of course, the present invention may be implemented using other programming techniques and development environments as well.

In view of the above, it should be appreciated that some portions of the detailed description that follows are presented in terms of algorithms and symbolic representations of operations on data within a computer memory. These algorithmic descriptions and representations are the means used by those skilled in the computer science arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. It should be borne in mind, however, that all of these and similar terms are to be associated with the appropriate physical quantities and are merely convenient labels applied to these quantities. Unless specifically stated otherwise, it will be appreciated that throughout the description of the present invention, use of terms such as “processing”, “computing”, “calculating”, “determining”, “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention can be implemented with an apparatus to perform the operations described herein. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and processes presented herein are not inherently related to any particular computer or other apparatus. Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor or by any combination of hardware and software. One of ordinary skill in the art will immediately appreciate that the invention can be practiced with computer system configurations other than those described below, including hand-held devices, multiprocessor systems, microprocessor-based or programmable consumer electronics, DSP devices, network PCs, minicomputers, mainframe computers, and the like. The invention can also be practiced in distributed computing environments where tasks are performed by remote processing devices that are linked through a communications network.

In some embodiments, computer-readable instructions embodying methods of the present invention may be stored on computer systems commonly referred to as “servers”, which are accessible by various “clients” through the Internet. Such software as hosted at one or more servers may thus be accessed by individuals from anywhere Internet access is available. While it is presumed that many readers will have a through understanding of Internet technologies, the following summary thereof is provided for those less familiar with these forms of computer systems and networks.

The Internet is a vast and expanding network of computers and other devices linked together by various telecommunications media, enabling all the computers and other devices on the Internet to exchange and share data. A computer or resource that is attached to the Internet is often referred to as a “host”. Examples of such resources include conventional computer systems that are made up of one or more processors, associated memory (typically volatile and non-volatile) and other storage devices and peripherals that allow for connection to the Internet or other networks (e.g., modems, network interfaces and the like). The precise hardware configuration of the hosting resource is generally not critical to the present invention. The content stored by various Internet hosts provides information about a myriad of corporations and products, as well as educational, research and entertainment information and services.

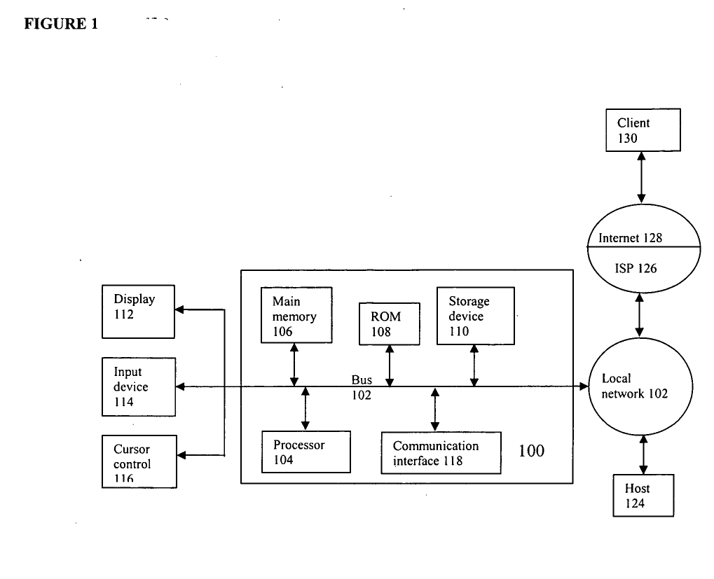

In most cases, the hosting resource may be embodied as hardware and/or software components of a server or other computer system that includes an interface module, which allows for some dialog with a user, and that may process information through the submission of Web forms completed by the user. Generally, such a server will be accessed through the Internet (e.g., via Web browsers) in the conventional fashion. Operating in conjunction with the interface module may be a communication interface that supports the distribution of electronic mail (e-mail) messages to or from other Web sites or users. An example of a hosting resource suitable for use in connection with the present invention is illustrated in FIG. 1, which is a block diagram illustrating an exemplary computer system 100.

Computer system 100 includes a bus 102 or other communication mechanism for communicating information, and a processor 104 coupled with the bus 102 for processing information. Computer system 100 may be a server or a client depending on its role in a particular communication session. Here, it will be assumed to be a server.

Computer system 100 includes a main memory 106, such as a random access memory (RAM) or other dynamic storage device, coupled to the bus 102 for storing information and instructions to be executed by processor 104. Main memory 106 also may be used for storing temporary variables or other intermediate information during execution of instructions to be executed by processor 104. Computer system 100 further includes a read only memory (ROM) 108 or other static storage device coupled to the bus 102 for storing static information and instructions for the processor 104. A storage device 110, such as a magnetic disk or optical disk, is provided and coupled to the bus 102 for storing information and instructions.

Computer system 100 may be coupled via the bus 102 to a display 112, such as a cathode ray tube (CRT) or a flat panel display, for displaying information to a computer user. An input device 114, including alphanumeric and other keys, is coupled to the bus 102 for communicating information and command selections to the processor 104. Another type of user input device is cursor control 116, such as a mouse, a trackball, or cursor direction keys for communicating direction information and command selections to processor 104 and for controlling cursor movement on the display 112. This input device typically has two degrees of freedom in two axes, a first axis (e.g., x) and a second axis (e.g., y) allowing the device to specify positions in a plane.

Generally, processor 104 executes sequences of instructions contained in main memory 106. Such instructions may be read into main memory 106 from another computer-readable medium, such as storage device 110. However, the computer-readable medium is not limited to devices such as storage device 110. For example, the computer-readable medium may include a floppy disk, a flexible disk, hard disk, magnetic tape, or any other magnetic medium, a CD-ROM, a DVD-ROM, any other optical medium, punch cards, paper tape, any other physical medium with patterns of holes, a RAM, a PROM, an EPROM, a FLASH-EPROM, any other memory chip or cartridge, a carrier wave embodied in an electrical, electromagnetic, infrared, or optical signal, or any other medium from which a computer can read. Execution of the sequences of instructions contained in the main memory 106 causes the processor 104 to perform the process steps described herein. In alternative embodiments, hard-wired circuitry may be used in place of or in combination with computer software instructions to implement the invention. Thus, embodiments of the invention are not limited to any specific combination of hardware circuitry and software.

Computer system 100 also includes a communication interface 118 coupled to the bus 102. Communication interface 108 provides a two-way data communication as is known. For example, communication interface 118 may be an integrated services digital network (ISDN) card or a modem to provide- a data communication connection to a corresponding type of telephone line. As another example, communication interface 118 may be a local area network (LAN) card to provide a data communication connection to a compatible LAN. In the preferred embodiment communication interface 118 is coupled to a virtual blackboard. Wireless links may also be implemented. In any such implementation, communication interface 118 sends and receives electrical, electromagnetic or optical signals which carry digital data streams representing various types of information. For example, two or more computer systems 100 may be networked together in a conventional manner with each using the communication interface 118.

Network link 120 typically provides data communication through one or more networks to other data devices. For example, network link 120 may provide a connection through local network 122 to another host computer 124 or to data equipment operated by an Internet Service Provider (ISP) 126. ISP 126 in turn provides data communication services through the Internet 128. Local network 122 and Internet 128 both use electrical, electromagnetic or optical signals which carry digital data streams. The signals through the various networks and the signals on network link 120 and through communication interface 118, which carry the digital data to and from computer system 100, are exemplary forms of carrier waves transporting the information.

Computer system 100 can send messages and receive data, including program code, through the network(s), network link 120 and communication interface 118. In the Internet example, a client 130 might transmit a request for an application program through Internet 128, ISP 126, local network 122 and communication interface 118. In accordance with the invention, computer system 100 may respond with an application that provides for information discovery, memorization and visualization as described herein. The received code may be executed by a processor at the client 130 as it is received, and/or stored in a local storage device at the client for later execution.

As previously indicated, in order to access the Internet 128 most clients 130 utilize computer programs known as “Web browsers”. Commercially available Web browsers include such well-known programs as Netscape's Navigator™, Apple's Saffari™ and Microsoft's Internet Explorer™. If an Internet user desires to establish a connection with a Web page hosted at computer.domain.com, the Internet user might enter into a Web browser program the uniform resource locator (URL) “http: www.domain.com”. The first element of the URL is a transfer protocol (most commonly, “http” standing for hypertext transfer protocol, but others include “mailto” for electronic mail, “ftp” for file transfer protocol, and “nntp” for network news transfer protocol). The remaining elements of this URL (in this case, “www” standing for World Wide Web—the Internet's graphical user interface—and “domain.com”) are an alias for the fully qualified domain name of the host computer.domain.com. Once a URL is entered into the browser, the corresponding IP address is looked up in a process facilitated by a top-level server. In other words, all queries for addresses are routed to certain computers, the so-called top-level servers. The top-level server matches the domain name to an IP address of a domain name server capable of directing the inquiry to the computer hosting the Web page.

One way to establish a presence on the Internet is by placing a Web page, which is, ultimately, a computer data file on a host operating a Web server within a given domain name. When the Web server receives an inquiry from the Internet, it returns the Web page data in the file to the computer making the inquiry. The Web page may be a single line or multiple pages of information and may include any message, name, word, sound or picture, or combination of such elements. Most Web browsers will show somewhere on the screen the domain name of the Web page being shown and will automatically include the domain name in any printout of the Web page. There is no technical connection or relationship between a domain name and the contents of the corresponding Web page.

There are a number of ways for an Internet user to find a Web page. Web browsers feature access to various indexes, commonly referred to as search engines. Well-known indexes include Google™ and Yahoo™. These indexes will allow the user to enter a name or a word or a combination of words, and will return the results of the search as a list of “hyperlinks” to Web pages that have information within or associated with the document making up the page responding to the search.

A hyperlink is a link from one site on the Internet to a second site on the Internet. “Clicking” (or, more generally, selecting using a cursor control device such as a mouse, joystick, touch pad, etc.) on a designated space on the initial site which references the subsequent site by a picture, highlighted text or some other indication will direct the user's browser from the initial site to the second site. In addition to their use in indexes, hyperlinks are commonly placed on Web pages, thus allowing Internet users to move from Web page to Web page at the click of a button, without having to type in URLs. Hyperlinks are also used to initiate the transfer of files or other information from the hosting resource to the user's computer in a process commonly known as downloading.

Hyperlinks can be and commonly are established without reference to the domain name of the second site. A hyperlink is not technically related to a domain name and therefore it can be identical to an existing domain name without conflicting with that domain name. For example, were the operator of a Web page known as SITE to establish a home page at http: www.xyz.com, any number of indexes could be employed and hyperlinks could be established to bring up the page through use of the word SITE.

In the context of the present invention, information may be presented to users and responses received therefrom through the use of Web forms. Generally, a form is a collection of form fields displayed as a Web page by a browser in response to hypertext mark-up language (HTML) tags and other information received from a Web server. An associated form handler resides at the server to collect and process the information submitted by a user via the form. By using such forms, an information collection process performed by a host is made interactive with the users thereof. That is, users can add text to text boxes, select from drop down menus and/or select check boxes and/or radio buttons, etc. Typically, the user submits the form by clicking on a submit button or other appropriately labeled element of the form and, upon such submission, the contents of the form are passed to the form handler. Depending upon the type of information being submitted and the type of form handler being used, the information submitted by a user may be appended to a file maintained by the host, for example a file associated with a temporary account assigned to the user or a larger database. In this way information may be collected, processed and displayed to those who access it.

A text box is a standard form field into which a user can type text. When a form containing a text box is submitted in a Web browser, the name and contents of the text box are provided to the form handler running on the server.

A check box field is typically arranged in a grid or matrix fashion with one or more cells of the matrix including a check box. Check box fields present a user with choices that can be made by clicking (e.g., selecting or deselecting as appropriate) a check box. Such fields are created and rendered using programming techniques common in the art and any number (including all or none) of individual check boxes may be selected or not. When a user submits a form containing a check box field, the name of each check box along with its value is provided to the form handler at the host.

Radio button fields present a user with a choice that can be made by selecting a button. Radio buttons are displayed in a set, only one of which may be selected at a time. When radio button fields are created, they are assigned a group name, and each button in the group is assigned a value and an initial state (selected or not selected). When the user selects one of the buttons in the field, all other buttons in the field take on a value of not selected. Then, when the user submits the form, the group name and value of the buttons is provided to the corresponding form handler at the server for processing.

Having thus provided some background regarding Internet technologies used by embodiments of the present invention, we now turn to a more detailed description of the algorithms which serve to facilitate the learning processes discussed above. In general, the knowledge management system of the present invention may be regarded as a database of knowledge that is communicatively coupled with an interface. A user accesses the database by means of the interface, and the questions to be posed to the user (which questions are tailored to test the user's memorization of the desired content) as well as the user's responses to those questions are processed through the interface by a processor that evaluates whether the answer is correct and also determines what level and type of question to next present to the user based on that determination. As indicated above, this knowledge management system can be implemented as one or more Internet web applications, stand-alone PC applications, or applications configured for use with handheld devices, such as personal digital assistants and/or mobile phones. The knowledge management system can serve a single user or multiple users, depending on the method of implementation. Because the present knowledge management system optimizes the memorization and learning process for each individual user, each user's data (e.g., question and response sessions) are separately processed, stored and analyzed. To provide access to this “customized” learning environment, embodiments of the present invention may provide for personal accounts which individual users may access via unique identifiers in the conventional fashion (e.g., user name/password combinations

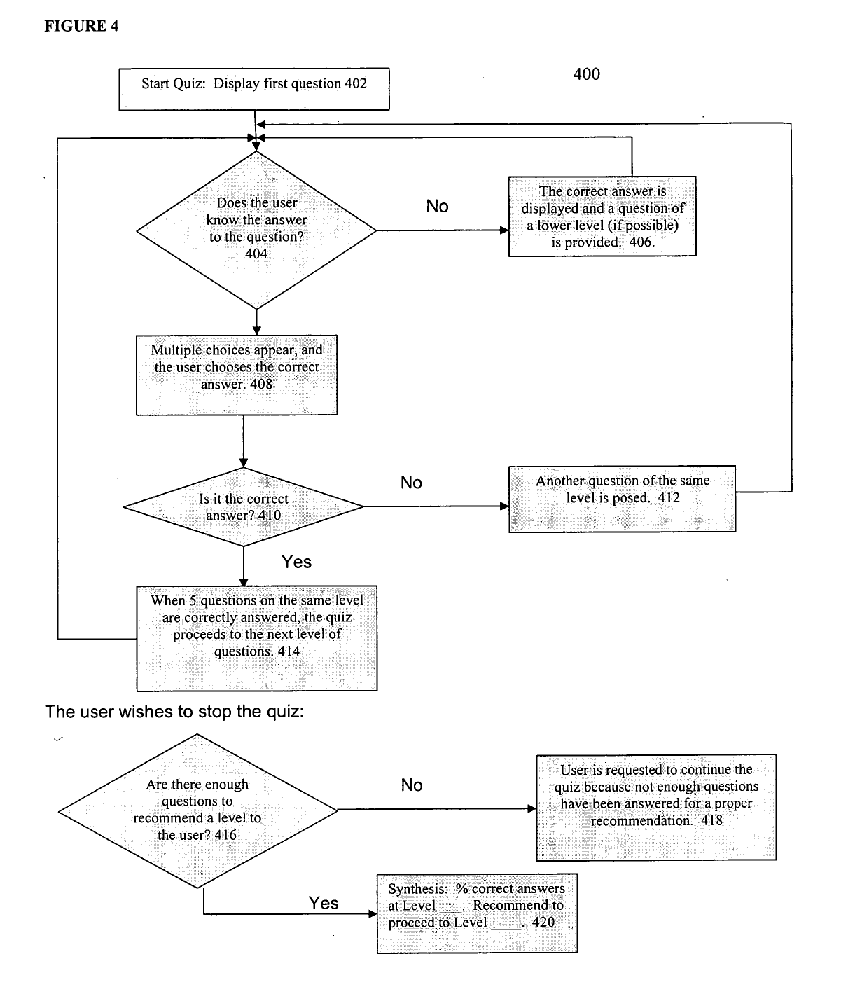

The interface component of the knowledge management system may make use of a client device generally configured as discussed above for computer system 100, including some or all of its peripheral units. This may include an output unit and an input unit. The output unit can be a visual and/or auditory display (e.g., computer display screen and/or speaker) configured for presenting at least some of the contents of the knowledge database. The interface may also display information related to the user's progress in learning and memorization of a given set of elements, the sets of elements being determined by the user in the subscription process (this is further discussed below in relation to FIG. 4). The input unit of the interface may be used to communicate the user's responses to various prompts and/or specific content that the user wishes to include in his/her personal cache within the overall system's knowledge database. The input unit can be any of a variety of forms, including but not limited to: a mouse, keyboard, keypad, joystick, microphone or other similar devices.

The knowledge database (which can be a server with associated storage devices as described above) stores the sets of elements (i.e., content) for learning and memorization. Each user has access to as much of the database to which s/he wishes to subscribe. The sets of elements in the database can be associative pairs, lists of elements, groups of related elements, or some variation thereof. The storage devices can be an integrated part of the server or other knowledge database host, or may be made of one or more removable units, such as a CD-ROM or a memory card. The content of the knowledge database can comprise a range of information, for example alphabet, word or concept learning, anatomy terms learning, behavioral training, or any other subject matter capable of being input into the system.

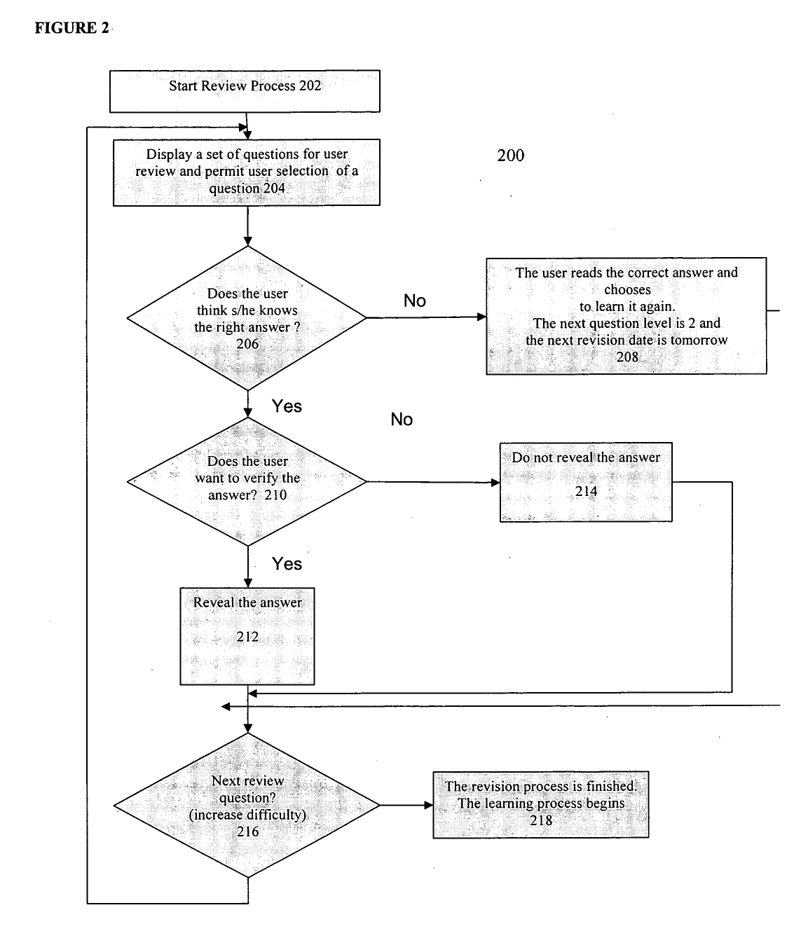

An embodiment of the present system includes a computer host that receives user inputs from the interface and delivers thereto content (from the knowledge database) to be presented to the user. In accordance with an embodiment of the present invention, an algorithm is used to track the status of each user's familiarity with the set of elements with which s/he is currently engaged and in response to that status optimizes the learning process (this is discussed further below with respect to FIG. 2) to ensure that every element is reviewed at an optimal time to achieve an efficient transfer of the knowledge into the user's long-term memory.

Further embodiments of the present invention include a knowledge management system structured on a question/answer format. The questions and answers can be captured/presented as text, sound, video, Braille, or some other visual or auditory means for communicating information. The information is dynamically updated through the knowledge management system, which process includes renewing the questions presented to the users at appropriate intervals and in appropriate formats.

In another embodiment of the invention, the question/answer format does not provide discrete answers to the question presented, but instead offers a series of questions that will bring to mind the desired association. For example, a user may not wish his ATM card PIN (personal identifier) number to be discretely placed into the knowledge base, but may want the system to help him/her recall that information through a series of associated questions that provide clues to the actual numerals comprising the PIN number. Hence, the system may be configured to pose a question to make the user remember the PIN number, without any clues or other prompts.

In an embodiment of the invention, the knowledge system includes profiles, topics or personal questions to be created. The topics comprise sets of questions assembled around a field or subject of study. Embodiments of the invention may include a system that allows access to related topics, to multiple topics at one time, or some combination thereof as determined by the user and/or an administrator who is serving as a guide to the user's memorization and learning process.

In yet another embodiment of the invention, the content structure of the knowledge management system may be fractal in nature in order to optimize responsibility definitions at each level through delegation of topics or profiles. Alternatively, or in addition, modifications of the threshold values may be performed by analyzing correlations between attribute values of defects lying in attribute trails.

In some cases, the knowledge management system may include a tool (e.g., in the form of computer-readable instructions for causing the desired functionality) that is capable of managing the questions the user wishes to save or to which s/he wishes to memorize the answers. The user can in this embodiment of the invention “feed” his/her “knowledge-stock” (i.e., the user's personalized knowledge database) with questions to which s/he provides the answers. The user can then ask the system to find the answer to specific questions to which s/he would like the answer but does not currently have—this answer would then be obtained from the collective database of knowledge of all users of the system. The answer may also be obtained through a direct query to other users of the system, who may know the answer themselves but have not input that information to the collective database. This method would then allow other users to provide a knowledge transfer directly to the original user posing the question. One can regard this as a “social search engine” in that a collection of users have agreed to share knowledge of various topics among themselves.

The Review Process

FIG. 2 is a flowchart illustrating an information review process 200 for use in accordance with an embodiment of the present knowledge management system. At the start 202 of the review process, the user is presented with a series of questions (step 204), for example three questions. The user is permitted to choose one of the questions, and is then prompted to indicate whether or not s/he thinks s/he knows the correct answer to that question (step 206).

If the user believes s/he does not know the answer to the question, s/he is shown the correct answer (e.g., as retrieved from the knowledge database) and the same question is then scheduled for further review at a specific time in the future (step 208). If, on the other hand, the user believes s/he does know the correct answer, s/he is given the opportunity to verify that his/her understanding is correct (step 210). Verification allows the user to test his/her knowledge. Thus, if the user chooses to verify his/her knowledge of the answer, the user can do so at step 212 by revealing the answer on the display.

If the user is confident and does not need to verify the answer (step 214), or upon reviewing the answer to the pending question, the review session continues (step 216) using ever increasing difficult questions until all of the review questions have been encountered. At the completion of the review process (step 218), the user enters the learning process.

In an embodiment of the invention, an outside entity, be it a friend, teacher, parent, knowledge expert, etc. guides or simplifies the user's review session. Such an individual would in this embodiment be able to provide or indicate the elements of information to be learned, the frequency with which the review sessions will be presented, and the hierarchy of the questions to guide the user from easiest to most difficult questions. Or, the user (or his/her mentor) can access and modify the set of questions presented to more deeply learn items that offer the user difficulty. Further, an organization may implement associated services upon the successful completion of a particular set of review sessions or when a target accuracy level has been reached by the user.

In yet a further embodiment of the invention, the knowledge management system adapts dynamically to arrive at an efficient method of reviewing the user's knowledge of his/her personal knowledge stock. For example, the knowledge management system may be configured to suggest to the user that it is time for a review session using an algorithm that does not diverge rapidly. The time between review sessions may then follow an exponential law the parameters of which depend on the mnemonic abilities of each user and can be question-dependent. If the user forgets an answer, the cycle is refreshed.

The Learning Process

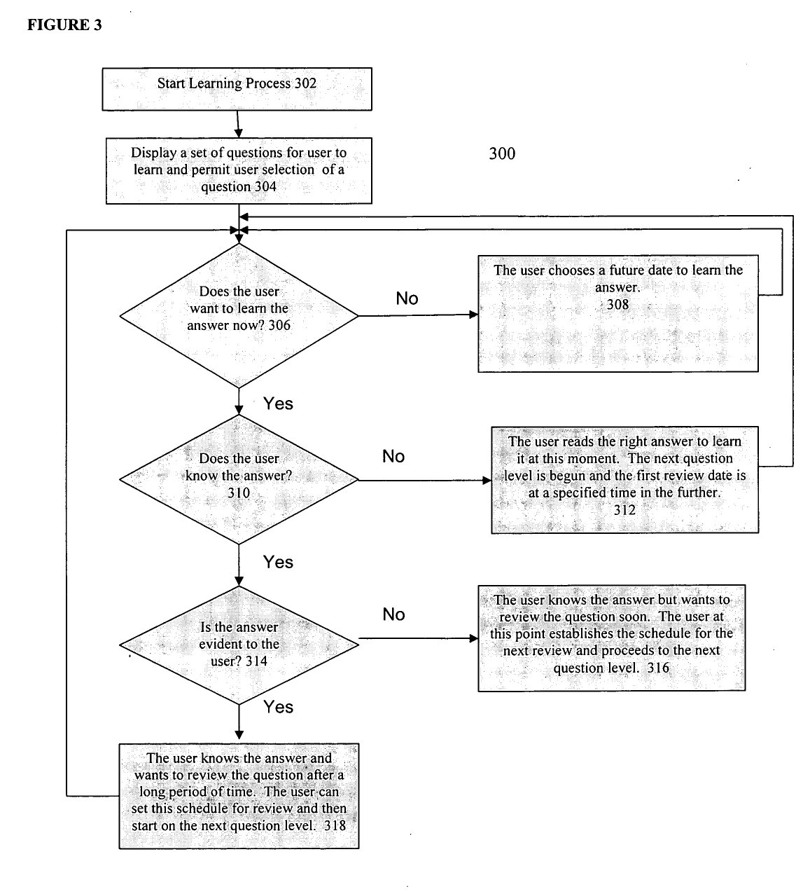

FIG. 3 is a flowchart illustrating a learning process 300 for use in accordance with an embodiment of the present knowledge management system. The learning process is adapted to permit a user to learn new information (e.g., as stored in a knowledge store populated by a knowledge expert and/or other users). The learning process makes use of the same sort of question and answer format as the rehearsal or review process.

At the start 302 of the learning process, the user is presented with a series of questions, (step 304), for example three questions. The user is permitted to choose one of the questions and is then prompted to indicate whether or not s/he would like to learn the answer to that question now (step 306). If the user does not wish to learn the answer now, s/he may choose a future date and time to do so (step 308). If the user wishes to learn the answer, s/he is prompted with the query of whether she already knows the answer (step 310). If s/he does not know the answer to the question, the correct answer is displayed and a future first review date is chosen (step 312). If the user knows the answer to the question, s/he is asked whether s/he is comfortable with the knowledge represented by this question answer pair (step 314). If s/he is not yet comfortable, s/he may choose to review the question in a short amount of time (step 316). If s/he is comfortable with this information, s/he can set the time for review for far into the future (step 318).

In an embodiment of the invention, a mnemonic evaluation of the user's learnt knowledge is made, and adjustments are made to the review sessions to keep to the learning scope and schedule, with said scope and schedule being accessible to the user at any time should he wish to change any parameters.

Further, the user may be permitted to provide feedback in cases where he/she wishes to comment on the questions and/or the answers. For example, if the user disagrees with an answer to a question or believes the format of the question does not provide a sufficient prompt for the associated answer, the user may provide feedback regarding these issues. The feedback may be reviewed by a service provider offering a knowledge management service that incorporates the present invention, or by a subject matter expert or other person responsible for maintaining the knowledge store being accessed by the user through the learning process. This provides the service provider or other individual responsible for maintaining the knowledge store with the opportunity to revise, update or change questions and/or answers to address the user's concerns or comments.

The Quiz Process

FIG. 4 is a flowchart illustrating a quiz process 400 for use in accordance with an embodiment of the present knowledge management system. This quiz process is designed to establish a user's present level of knowledge in a subject matter area that the user now wishes to learn more about. That is, through an interactive quiz, the knowledge management system determines the user's present knowledge in a specified subject matter area so that the learning (or other) processes may be initiated at an appropriate level. In this case the user is not necessarily rehearsing against his/her own knowledge store. Rather, the user is “tested” against an existing knowledge store, for example, a knowledge store populated with information (questions and answers) by a knowledge expert and/or other users.

At the start of the quiz (402) the first question is displayed and the user is asked if s/he knows the answer (step 404). If s/he does not know the correct answer, the correct answer is displayed (step 406) and a question of a lower level is provided if available. If the user does know the answer to the question, multiple choices appear and s/he chooses the choice she believes correctly answers the displayed question (step 408). If s/he does not choose correctly, another question of the same level is posed (step 412). Once a pre-determined number of questions is answered correctly (the flowchart shows 5 questions as an example), the quiz proceeds to the next level of questions (step 414).

In another embodiment, the user can manually halt the quiz process (step 416), and the system determines whether enough questions have been answered to render a decision as to whether the user should proceed to the next level of questions. If the number of questions answered is too small to provide a proper recommendation, the user is requested to answer more questions (step 418). If a recommendation can be provided, the number correct at the current level is displayed and a recommendation to proceed to the next level is provided (step 420).

The Subscription Process

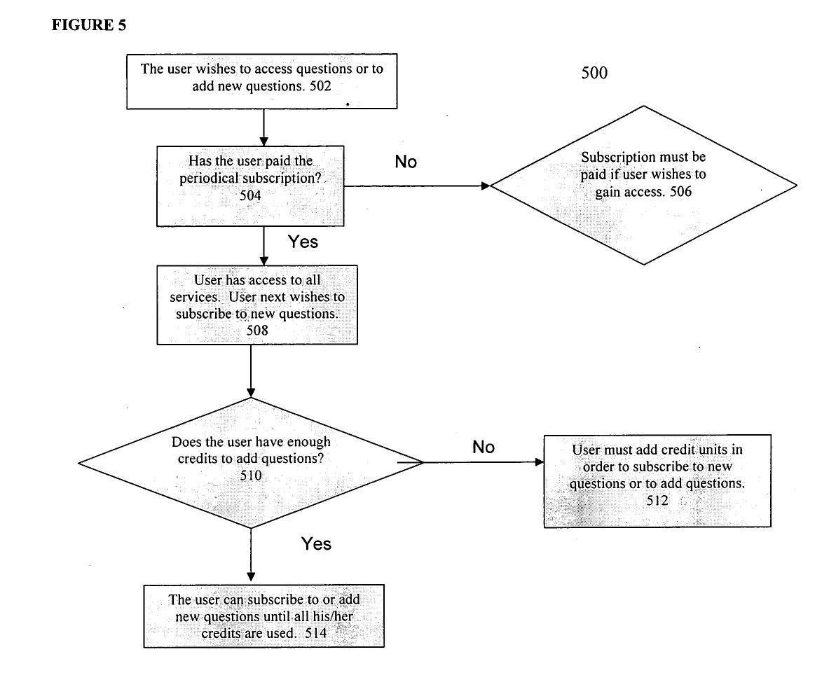

FIG. 5 is a flowchart illustrating a subscription process 500 for use in accordance with an embodiment of the present knowledge management system. The subscription process allows users to add to their individual knowledge stores and/or access other features of the knowledge management system.

At the start of the process 502, the user tries to add new questions. If s/he has not paid the periodical subscription (step 504), an error message appears and the user is told that the subscription must be paid for access (step 506). If the subscription has been paid, the user has access to the services of the knowledge management system. If the user wishes to subscribe to new questions or to add to his/her own database of questions, the system determines whether s/he has enough credits to perform this task (step 510). If s/he does not have the credits, s/he will be required to add credits in order to subscribe to new questions or to add new questions (step 512). If s/he has enough credits, s/he can add new questions or subscribe to new questions until all his/her credits have been consumed (step 514).

In an embodiment of the invention, the user registers on line at a website that provides the interface to the knowledge management system. The user adds value units (such as dollars) to gain access to the system. The user can then add his own questions and answers for his particular store of information.

One embodiment of the invention allows the user access to the collective knowledge stock of all users of the system, to which he can add his own information and data. In another embodiment, the user has his own cache of knowledge, to which he may add from the collective database that contains all users' information. In this embodiment, the user has carved out a space within the knowledge management system that comprises the data and information he puts into the system as well as data and information he has chosen from the collective knowledge base of all users of the system.

In an embodiment of the invention, the system allows the user to input questions for his personal cache of knowledge in a variety of different ways, including choosing to buy question/answer items from the existing collective database, choosing to subscribe to specific profiles or fields of knowledge, to purchase information from the collective database based on an evaluation of his knowledge of the selected topic or profile, said evaluation being accomplished by the system. The system may also provide suggestions for alternates to the user's chosen fields/profiles of knowledge, said suggestions being based on user's prior history on the knowledge management system and any evaluations the user has undergone by the system.

In an embodiment of the invention, the system plans the user's learning of his personal stock of knowledge by allowing the user to limit the number of questions per day. In another embodiment, said plan is provided by allowing the user to give priorities to specific questions, allowing the system to sort the questions according to the specified priorities and then set up a plan for learning and review of those questions.

Associative Learning Tasks

In embodiments of the invention, the knowledge elements are organized in a tree-structure of topics. These topics are managed by administrators with roles based upon fractal theory. The tree structure includes delegation to ensure that the content contained in the system is verified and validated by competent individuals at each level. Such individuals ensure the reliability of the answers, the relevance of the questions, and also serve as a check to guard against intrusion by inappropriate or illegal content.

In embodiments of the invention, the system is used to help an institution retain specific elements of knowledge that are of value to the functioning of that institution. For example, a bank requires specific security protocols to safeguard the safety of its vault and of its personnel. Since turnover in human resources is a fact of life of any organization, it is necessary for specific aspects of institutional knowledge, such as security protocols, be transferred to new personnel. The instant invention provides a reliable and efficient method of knowledge transfer. In such an embodiment, the institution would maintain a subscription to the knowledge database and would populate its personal cache of the database with, in this example of a bank, the security protocols. When a new individual joins the bank's staff, he is provided with access to the knowledge system and will then be able to proceed through the learning, review and quiz processes until he has learned and memorized the protocols necessary. Maintaining such a system allows the institution to maintain continuity in its practices without needing to maintain continuity in its personnel.

From the above then it should be apparent that the methods and systems of the present invention provide facilities for assisting individuals in retaining information they have previously learned and for learning new information. More than just a rehearsal mechanism (to provide rote memorization, for example), the present invention allows users to expand their “knowledge database” through guided paths. Using the question and answer formats discussed above, the present invention allows users to enter new knowledge (i.e., information to be learned/remembered), find answers to given questions, plan new learning, maintain his/her knowledge of one or more subjects, and, if desired, share that knowledge with others. Access can be (and preferably is) achieved through the Web-based interface, but in other embodiments the methods described above may be embodied in stand-alone programs to be implemented by a personal computer or like device.

As further indicated above, individual users are permitted the freedom to define that set of information which each such user wants to learn or maintain. Access to that content is then provided through a set of questions and corresponding answers designed by the user. Thus, the present invention allows for variations in the way in which different users learn information, allowing each user to tailor a learning process to suit his/her own abilities and preferences.

Feedback is provided in several forms. For example, a list of knowledge items which a user has had difficulty remembering can be provided at the end (or other time during) of a learning session (e.g., a rehearsal session). This allows the user to focus on those items which have proved the most difficult for him/her to master. For example, the difficult items of a particular session, day or other learning period may be so provided. In some cases this information may be displayed graphically so as to allow a user to design his/her future revision sessions/efforts. In some cases, these revision efforts may be directed with a specific deadline or other target date in mind. Summaries or status of past sessions may also be provided for evaluation.

The question and answer format of the above-described methods provides a structure for learning. Each piece of information may have certain parameters (such as desired time to learn, specific mnemonic characteristics, etc.) associated with it, and may come in any one or more of several forms (e.g., text, audio, video, Braille, etc.). In cases where the information is subject to change (e.g., dynamic information, subject to change over time, such as the name of the current President of the United States, for example), the above-described methods may be modified to accommodate warning messages to the user alerting him/her to the fact that the stored information may be out-of-date (in which case it should be updated). Similarly, the timeliness of a piece of information may be used as a trigger to initiate a new learning cycle so that the user is assured of being exposed to the most recent available form of the associated information.

In some cases the information to be learned may involve personal or confidential information which the user does not want to expose. For example, personal passwords and other secrets are sometimes difficult to remember, but this is the sort of information a user would not typically want to expose to others. Hence, the above-described methods of interrogation may be used to prompt the user to remember such information without having to actually commit it to the database. That is, the mere act of being asked to remember a password may be all that is needed to actually remember it, without having to actually store the password in the database for later referral.

The information elements may be stored in tree-like hierarchies for different topics. In some cases, topics may be managed by administrators (individuals known to have superior knowledge in a particular area, for example). Profiles may then be created (and uses associated with these profiles) which define a particular set of questions allowing for the formalization of knowledge expected for a given category of users defined by each profile. For example, a profile for a first grade arithmetic student may be developed and a series of questions designed therefor in order to ensure that any user fitting the profile will have mastered the information associated with those questions. Such profiles can become the basis for examinations and/or for self-directed learning. Other topics can, of course, be accommodated.

In some cases, a social network-like community may be formed around embodiments of the present invention. For example, a community of users may be created in which a knowledge sharing process develops. In such a community, different users may commit different knowledge elements to storage and, if desired, pose questions to that knowledge database to learn information they do not otherwise possess. In addition to information, users can store questions as well. In cases where a particular answer is not yet part of the knowledge store, the question may be circulated (e.g., by e-mail or other communication means) to other users of the system and, if one of those users knows the answer he/she may commit same to the knowledge store for later retrieval.

In addition to the profile-based learning process discussed above, users may choose information they wish to learn in other ways. For example, users may simply choose a topic or field of knowledge that they wish to learn above (e.g., U.S. history) and a level of knowledge (e.g., beginner, intermediate or expert) therefor. In response, the methods of the present invention may draw upon a previously created knowledge bank for the selected topic and level of knowledge and begin a series of question and answer session that are tailored to the appropriate field/topic.

In some cases, where a topic is very diverse for example, a user may be prompted to select specific questions or otherwise narrow the field of interest so that a workable number of questions/answers may be selected for each learning session. In still other cases, a user may be permitted to enter his/her own questions (perhaps associated with already available answers or answers supplied by the user) for rehearsal.

Before beginning a particular learning session, the system may guide the user through an evaluation or quiz process designed to evaluate the user's present level of knowledge in a particular subject area. In this way material which the user already knows very well may only be revisited at long periodic intervals, which information less familiar to the user (or, indeed, unknown to the user) may be rehearsed more frequently.

As indicated above, there are different manners in which learning sessions can be planned. In some cases, constraints on the number of information items to be rehearsed each week/day/hour, etc. may be in place. In such cases, once a user masters a given set of information items, new items may be substituted therefor. This may be substitution of an entire information set or merely of a subset thereof as the user masters different information elements at different times.

In other cases, priority may be given to information elements of a particular kind or nature, for example in advance of an upcoming examination in a particular subject area. The user may be permitted to establish such priorities and/or dates certain by which certain information must be learned/memorized. The present methods may then be configured to take into account such priorities and ensure that the associated information elements are treated so as to help ensure learning thereof by the applicable deadlines.

Once a set of questions has been planned (either based on a priority schedule or another criteria), the information is organized for rehearsal through the above-described processes. Times between revisions of various information elements may be based on the user's progress or on other bases. For example, in some cases the time between revisions can follow an ever increasing exponential law, the parameters of which depend on mnemonic abilities demonstrated by the user and also each question. These repetition cycles may be rest (either to the beginning or a point thereafter) if the users answers a question incorrectly or indicated he/she does not know a particular answer. In some cases, as indicated above, a user will first be asked if he/she knows an answer and will then have an opportunity to check that answer against the stored knowledge item. If the user knew the correct answer he/she can indicate same. If not, a new repetition cycle can be initiated for the associated information element. This process can, in some cases, be overridden by a user (or supervisor, e.g., a parent) if he/she wants to revise the learning process.

In a particular embodiment, the present methods and systems are offered as a subscription-based service via the Internet. Users are permitted to register with the service and thereby gain access to the knowledge store (e.g., for a fee). In some cases users can access a collective knowledge store and/or maintain a personal knowledge store for their own information. Users may also contribute to the global knowledge store (potentially for some form of compensation) if they so choose.

In one example, the knowledge management system may be operated as an Internet-based service. Users are permitted to register and access the knowledge management service, for example by incorporating knowledge stocks produced by others into their personal knowledge stores for later learning/rehearsal. Thus, the knowledge management system also permits the knowledge experts to provide various knowledge modules (knowledge stocks) for later access by individual users. The knowledge modules may be of various levels (beginning, intemediate, advanced, etc.), various subject matters, etc. Importantly, however, user access to this information is provided through the familiar question and answer formats discussed above. Thus, a user can work through several different knowledge stocks, in different subject areas and at different levels, but all the while using the familiar question and answer format provided by the present invention.

Thus, a system to optimize the human learning and memorization process has been described. Readers should remember, however, that a wide variety of modifications, alterations, and combinations can be made with respect to the above described embodiments of the invention without departing from the spirit and scope thereof, and that such modifications, alterations, and combinations are to be viewed as being with the ambit of the present invention's concept. Indeed, the invention should only be measured in terms of the claims, which follow.

We claim:

1. A method for knowledge transfer, comprising: populating a computer-based educational system with a set of associative elements; and automatically and selectively presenting said elements in one or more cycles for rehearsing by a user in a manner adapted to and appropriate for the user's current level of comprehension and memorization of content of said elements.

2. The method of claim 1 wherein selectively presenting comprises providing the user with an opportunity to select whether or not to review answers associated with one or more of the elements.

3. The method of claim 1, wherein the elements are presented via an Internet host.

4. A method for knowledge transfer, comprising accepting, via an interface of a computer-based educational system, a set of associative elements provided by a user of said educational system; and presenting to said user content included in said elements in one or more rehearsal cycles adapted to the user's demonstrated knowledge of said content during each of said rehearsal cycles.

5. A method comprising receiving content at a computer-based educational system from a first user, the content including of one or more sets of associative elements, each of which includes a first element and one or more elements associated with the first element; and automatically providing the content to a second user of the educational system according to a rehearsal schedule configured to determine which first elements of the one or more sets of associative elements to provide and at what frequency based upon the second user's past performance in choosing correct ones or more related elements associated with respective ones of the first elements.

6. The method of claim 5 wherein the associative elements are based on at least one of a vocabulary word list generated from a literary work, the literary work author, and the literary work content.

7. A learning system, comprising a computer-readable storage medium containing sets of associated elements; an interface adapted to provide a user with access to the associated elements; and processor configured to operate under the control of computer-readable instructions for determining a next set of the associated elements to present to the user based on the user's performance with earlier sets of the associated elements, which performance is evidenced by the user's memorization of information embodied in said associated elements.

8. The system of claim 7, wherein the computer-readable instructions comprise review, learning and quiz processes configured to be administered by a third party serving as a guide for the user in said user's process of memorization.

9. The system of claim 7, further comprising means for the user to populate the computer-readable storage medium with the sets of associated elements.

10. The system of claim 9, wherein the sets of associated elements are associated with a profile of the user.

11. The system of claim 7, wherein the computer-readable instructions, when executed by the processor, cause the processor to select individual ones of the sets of associative elements for presentation to the user at a frequency based upon the user's past performance for the selected associative elements.

12. A computer-aided knowledge management process, comprising planning a learning process for a user, the learning process adapted to permit learning of one or more information elements by the user, and executing the learning process by interrogating the user with questions which the user would like to be able to answer, the answers to the questions being the information elements.

13. The computer-aided knowledge management process of claim 12, wherein the questions are developed by the user.

14. The computer-aided knowledge management process of claim 12, wherein the answers comprise some or all of: text, sounds, video, or Braille information elements.

15. The computer-aided knowledge management process of claim 12, wherein at least some of the information elements are not stored in a database but instead are retained only in the user's memory.

16. The computer-aided knowledge management process of claim 12, further comprising storing at least some of the information elements in a computer-readable medium for retrieval during the learning process.

17. The computer-aided knowledge management process of claim 16, wherein the learning process comprises a process in which questions are repeated according to mnemonic capabilities demonstrated by the user during the learning process.

18. The computer-aided knowledge management process of claim 17, wherein the learning process is revisable by the user so as to alter the frequency of repetition of the questions.

19. The computer-aided knowledge management process of claim 16, wherein the questions are selected from a knowledge database according to a category of interest selected by the user.

20. The computer-aided knowledge management process of claim 19, wherein the category of interest comprises a user-type profile.

21. The computer-aided knowledge management process of claim 19, wherein access to the knowledge database is provided on a subscription basis.

22. The computer-aided knowledge management process of claim 12, wherein the learning process includes a review process in which the user is permitted to choose one of the questions, and is then prompted to indicate whether or not the user thinks s/he knows a correct answer to that question.

23. The computer-aided knowledge management process of claim 22, wherein if the user believes s/he does not know the correct answer to the one of questions, the user is shown the correct answer.

24. The computer-aided knowledge management process of claim 23, wherein the correct answer is retrieved from a knowledge database.

25. The computer-aided knowledge management process of claim 23, wherein the one of the questions is scheduled for further review at a time in the future.

26. The computer-aided knowledge management process of claim 23, wherein if the user believes s/he does know the correct answer, s/he is given the opportunity to verify that his/her understanding is correct.

27. The computer-aided knowledge management process of claim 26, wherein verification comprises a process in which the user tests his/her knowledge.

28. The computer-aided knowledge management process of claim 27, wherein verification comprises revealing the correct answer to the user.

29. The computer-aided knowledge management process of claim 28, wherein upon reviewing the correct answer to the one of the questions, the learning process continues using ever increasing difficult questions.

30. The computer-aided knowledge management process of claim 29, further comprising dynamically adapting the interrogating to arrive at an efficient method of reviewing the user's knowledge of his/her personal knowledge stock.

31. The computer-aided knowledge management process of claim 30, wherein dynamically adapting includes suggesting to the user that it is time for a review session using an algorithm that does not diverge rapidly.

32. The computer-aided knowledge management process of claim 12, wherein one or more of the answers comprise dynamic answers subject to change over time.

33. The computer-aided knowledge management process of claim 12, wherein the learning process is planned by a mentor of the user.

34. A computer-aided knowledge management process, comprising populating a knowledge store with information elements obtained from one or more knowledge experts; and interrogating a user via a question and answer session to determine the user's present knowledge level in a subject matter of the information elements.

35. The computer-aided knowledge management process of claim 34, further comprising initiating a learning process for the user according to the user's determined present knowledge level in the subject matter of the information elements, the learning process involving a second question and answer session.

36. The computer-aided knowledge management process of claim 35, wherein one or more of the information elements comprise dynamic information elements subject to change over time.

37. The computer-aided knowledge management process of claim 35, wherein in the second question and answer session, questions and answers comprise any of text, sounds, or videos.

38. A computer-based knowledge management process, comprising automatically and selectively presenting information elements for learning by a user through a question and answer session in which the user is interrogated in one or more cycles for learning subject matter represented by the information elements, and receiving feedback from the user regarding the content of questions and answers presented during the session.

39. The method of claim 38 wherein selectively presenting comprises providing the user with an opportunity to select whether or not to review answers associated with one or more of the questions.

40. The method of claim 38, wherein the questions and answers are presented via an Internet host.

41. The method of claim 38, wherein the answers comprise some or all of: text, sounds, video, or Braille information elements.

42. The method of claim 38, wherein at least some of the information elements are not stored in a database but instead are retained only in the user's memory.

43. The method of claim 38, further comprising storing at least some of the information elements in a computer-readable medium for retrieval during the question and answer session.

44. The method of claim 43, wherein the questions are repeated according to mnemonic capabilities demonstrated by the user during the question and answer session.

45. The method of claim 44, wherein the frequency of repetition of the questions is revisable by the user.

46. The method of claim 43, wherein the questions are selected from a knowledge database according to a category of interest selected by the user.

47. The method of claim 46, wherein the category of interest comprises a user-type profile.

48. The method of claim 46, wherein access to the knowledge database is provided on a subscription basis.

49. The method of claim 38, further comprising revising one or more of the questions or answers based on the feedback from the user.

50. The method of claim 38, wherein the information elements are selected by a mentor of the user.

51. A computer-based service, comprising an Internet host configured to facilitate storing of information elements in a knowledge store accessible by the Internet host, the information elements provided by any of: users of the computer-based service, subject matter experts, or a provider offering the computer-based service; and providing of the information elements to users of the computer-based service through question and answer sessions involving the users.

52. The computer-based service of claim 51, wherein providing the information elements includes a learning process adapted to permit one or more of the users to learn new information as stored in the form of information elements in the knowledge store.

53. The computer-based service of claim 52, wherein the Internet host is further configured to provide an interactive session with one or more of the users to allow the users to remember information elements.

54. The computer-based service of claim 52, wherein the Internet host is further configured to determine individual users' present level of knowledge in one or more subject matter areas through an interactive quiz.
